(19) United States
(12) Patent Application Publication
(10) Pub. No.: US 2026/0200157 A1
(43) Pub. Date: Jul. 16, 2026

(54) EXTRUSION ROLLER APPARATUS AND NIP ASSEMBLY INCLUDING THE APPARATUS

(71) Applicant: AMCOR FLEXIBLES NORTH AMERICA, INC., Neenah, WI (US)

(72) Inventor: Thomas M. TIFT, Joplin, MO (US)

(21) Appl. No.: 19/443,903

(22) Filed: Jan. 8, 2026

Related U.S. Application Data
(60) Provisional application No. 63/743,683, filed on Jan. 10, 2025.
(60) Provisional application No. 63/909,211, filed on Oct. 31, 2025.

(51) Int. Cl. B29C 48/154; B29C 48/00; B29C 48/07

(52) U.S. Cl. CPC B29C 48/154; B29C 48/0011; B29C 48/0021; B29C 48/07; B29K 2023/06; B29K 2827/18; B29K 2905/12; B29K 2995/007; B29K 2995/0097

(57) ABSTRACT

A roller and extrusion nip assembly are disclosed for extrusion coating and lamination. The roller includes a steel core, an intermediate rubber layer, and an outer sleeve of fluorinated ethylene polymer (FEP) or perfluoroalkoxy alkane (PFA). The outer sleeve extends in a single piece along at least half of the roller length and is polished to achieve controlled surface roughness. The rubber layer provides compliance for web handling, while the fluoropolymer sleeve prevents sticking of extruded polymer melt. The roller exhibits hardness between 55 and 95 Shore A, with the intermediate layer hardness between 40 and 70 Shore A. Integrated into a nip assembly with a chill roll, backing roll, and die, the roller eliminates the need for Teflon tape bands, reduces downtime from roll wraps, and supports high-speed operation while maintaining product quality.

### TECHNICAL FIELD

This disclosure is related to rollers configured for use in extrusion nip assemblies and intended to be in contact with extruded polymer melt.

### BACKGROUND

In the extrusion coating or extrusion lamination process, a polymer is melted under heat and pressure in an extruder and the molten polymer is extruded through a slit die to form a web having a flat profile. This web, at high temperature, is drawn out of the die and coated onto a flexible substrate in a nip assembly formed by a water-cooled chill roll and a pressure roll. Typically the pressure roll is a rubber covered roller. The substrate to be coated is fed continuously from an unwind reel over the rubber pressure roll into the nip where the laminate is formed by pressing the two layers together. The laminate is rapidly cooled by the chill roll and is taken up by a wind-up mechanism.

The nip is formed by the steel chill roll and the rubber-covered pressure roll. The chill roll is usually chromium-plated and highly polished, although matte and “mirror pocket” surface finishes are sometimes used. It is designed to remove the maximum amount of heat from the polyethylene, and its construction is usually based on a double-shell arrangement with built-in spiral baffles to ensure effective and regular cooling. The cooling medium is water, circulated from a separate storage tank in which it can be maintained at a set temperature. It is essential to provide sufficient water to ensure effective temperature control at the surface of the roll. The diameter of the roll, which is determined by the working speed range, must be large enough to significantly reduce the temperature of the laminate during its brief period of contact.

In a typical set up, the rubber-covered pressure roll is in contact with a film such as oriented polyester, oriented polyamide, oriented polypropylene. The melted polymer extrudate applied to the opposite side of the film only contacts the rubber-covered pressure roll at each edge where the melt overruns the film it is being applied to. To avoid sticking, Teflon tape bands may be wrapped around the roller at the location of the exposed edge of the melt curtain.

U.S. Pat. No. 5,738,754 describes a roller assembly having an intent to eliminate the need for the Teflon tape band typically used. Here, the inventors describe a roller having a surface layer divided into a center region of a pressure sensitive material and two end regions, the end regions made of a material resistant to wetting by the molten polymer. This solution has many drawbacks including width change requirements (a different web width requires a different roller configuration), visual defects in the web produced, and overall complexity of design.

Failure of the fashioned tape bands and breaks in the film are frequent occurrences that allow the melt to contact and stick to the rubber-covered pressure roll. The sticking melt wraps the roller causing the entire process to be halted, resulting in significant downtime as the roller is cleaned and the line is cleared and restarted. It is desired to develop a nip assembly that reduces or avoids these issues.

### SUMMARY

In extrusion coating and lamination processes, molten polymer webs must extend beyond the edges of the substrate to ensure proper downstream handling and trimming.

However, this overhanging melt frequently contacts the rubber-covered pressure roll (i.e., roller), causing sticking, wrapping, and catastrophic line stoppages. Traditional solutions, such as applying Teflon tape bands or designing rollers with multi-material surfaces, are cumbersome, inflexible, and prone to failure. These approaches require frequent maintenance, limit adaptability to different web widths, and introduce significant downtime when the melt adheres to the roller surface.

The disclosed invention provides a roller apparatus and nip assembly specifically designed to overcome these limitations. The roller comprises a steel core, an intermediate rubber layer, and a continuous outer sleeve made of fluorinated ethylene polymer (FEP) or perfluoroalkoxy alkane (PFA). This outer sleeve extends along at least half the roller's length, preferably the entire length, and is polished to achieve a controlled surface roughness. The combination of the rubber intermediate layer and the polished fluoropolymer sleeve delivers both the necessary compliance for web handling and the release properties required to prevent sticking of the extruded polymer melt.

By integrating this roller into an extrusion nip assembly, the need for Teflon tape bands or complex multi-material roller designs is eliminated. The roller maintains excellent release characteristics, avoids wrinkling of the substrate, and supports high-speed operation without downtime due to roll wraps. Successful tests demonstrated continuous production at line speeds up to 1,500 feet per minute, with no sticking or interruptions, even when the melt extended beyond the substrate edges.

This invention therefore provides a robust, adaptable, and efficient solution to a longstanding problem in extrusion coating and lamination. It simplifies roller design, reduces maintenance, and enhances process reliability, enabling manufacturers to achieve higher productivity and consistent product quality.

In one aspect, a roller configured for contact with an extruded polymer melt includes a core including a steel base, an intermediate layer including rubber, an outer sleeve including fluorinated ethylene polymer (FEP) or perfluoroalkoxy alkane (PFA), and a hardness in a range of from 55 to 95, as measured by ASTM D2240 according to the Shore A scale.

In one aspect, a roller configured for contact with an extruded polymer melt includes a core including a steel base, an intermediate layer including a rubber selected from chlorosulfonated polyethylene synthetic rubber or silicone-based rubber, and an outer sleeve including fluorinated ethylene polymer (FEP) or perfluoroalkoxy alkane (PFA). The outer sleeve includes a polished exposed surface with an average roughness in a range of 5 to 10 Ra (microns) and extends in a single piece along at least 50% of the length of the roller, The roller has a hardness in a range of 55 to 95 as measured by ASTM D2240 according to the Shore A scale, and the intermediate layer is in direct contact with both the core and the outer sleeve.

In one embodiment an extrusion nip assembly includes a chill roll, a water-cooled backing roll, a roller as disclosed herein, and a die.

An embodiment of a method of extrusion coating or extrusion lamination includes providing an extrusion nip assembly as disclosed herein, feeding a substrate over the roller into a nip point between the chill roll and the roller, extruding a polymer melt from the die as a flat web, combining the substrate and the extruded polymer melt at the nip point such that the extruded polymer melt is between the substrate and the chill roll and the extruded polymer melt contacts the outer sleeve of the roller at the portions of the extruded polymer melt that extend beyond each edge of the substrate, and cooling the combined substrate and extruded polymer melt with the chill roll to form a laminate. Other technical features may be readily apparent to one skilled in the art from the following figures, descriptions, and claims.

### BRIEF DESCRIPTION OF THE DRAWINGS

The disclosure may be more completely understood in consideration of the following detailed description of various embodiments of the disclosure in connection with the accompanying drawings.

FIG. 1A illustrates an embodiment of a roller 100 as described herein.

FIG. 1B illustrates a cross sectional view of an embodiment of a roller 100 as described herein.

FIG. 2 illustrates an embodiment of an extrusion nip assembly 200 described herein.

FIG. 3 illustrates an embodiment of a roller 300 as described herein.

FIG. 4 illustrates an embodiment of an extrusion nip assembly 400 described herein.

The drawings show some but not all embodiments. The elements depicted in the drawings are illustrative and not necessarily to scale, and the same reference numbers denote the same features throughout the drawings.

### DETAILED DESCRIPTION

The inventors have unexpectedly found a nip assembly designed for extrusion coating or extrusion lamination, including a roller designed to overcome the drawbacks of previous designs. A roller including a steel core, a rubber coating on the steel core and a fluorinated ethylene polymer (FEP) or perfluoroalkoxy alkane (PFA) sleeve has been designed to have properties allowing for long life, excellent release from the melt portion of the web and good processing of the web, avoiding wrinkling.

In the extrusion coating process or the extrusion lamination process, a polymer such as polyethylene is melted under heat and pressure in an extruder and the molten polymer (i.e., extruded polymer melt) is extruded through a flat die as a thin web. This web, at high temperature, is drawn down and coated onto a flexible substrate in an extrusion nip assembly formed by a water-cooled chill roll and a roller. In the case of extrusion lamination, the web is drawn down into the nip between two flexible substrates. The edges of the extruded polymer melt extend beyond the edges of the substrate (or both substrates). In this manner, the molten polymer comes into contact with both the chill roll and the roller.

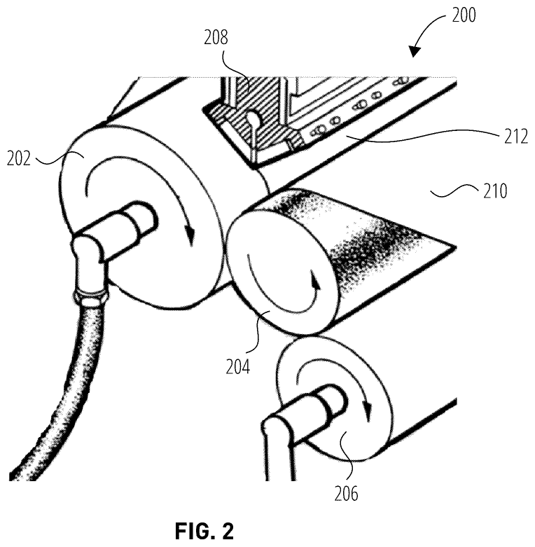

In previous designs, the roller used in conjunction with the chill roll in the extrusion nip assembly is a rubber-covered pressure roll. The substrate to be coated or laminated is fed continuously from an unwind reel over the roller into the nip where the laminate is formed by pressing the layers together and cooling the extruded polymer melt layer. The laminate is rapidly cooled by the chill roll and is taken up by a wind-up mechanism. The nip of the extrusion nip assembly (see FIG. 2) is formed by the chill roll and the roller.

It is not possible to coat the extruded polymer melt to the same width as the substrate. For the purposes of downstream web management, the extruded polymer melt must extend beyond the edge of the substrate on both sides. The process requires the molten polyethylene to extend out wider than the substrate it is being applied to. Subsequently, the side trim (consisting of the extruded polymer melt layer and/or substrate) is removed continuously by means of downstream slitting knives.

Using these previously used designs of the extrusion nip assembly and roller, the extruded polymer melt that extends beyond the edges of the substrate sticks to the rubber coating of a typical roller. To avoid the sticking issue, previous manufacturing processes require operators to apply Teflon tape bands either directly to the rubber coated roller, (in the areas of the extruded polymer melt overhang and slightly under the substrate), or using a Teflon belt system, to improve the service life of the rubber covering and to allow extrusion of a wider web. These Teflon tape bands or belts can be difficult or even dangerous to apply and tend to fail due to poor durability. Failure of the Teflon tape band leads to the extruded polymer melt sticking to the rubber roller surface, wrapping the roller and causing significant line downtime for clean up.

Previous designs also include complex roller designs that incorporate a multi-material surface. The center of the roller surface is the typical rubber material, allowing for good web control, and each end of the roller surface includes a polymer melt releasing material to prevent sticking. This roller design is complex in design and assembly and suffers from lack of flexibility. If the web width of material changes, the roller must be swapped out to incorporate a roller with the release material in the proper position. Additionally, the seams between the rubber material and the polymer melt releasing material cause visual defects in the produced web during coating or lamination (see the Comparative Examples herein for details).

It has been found that a full length (or nearly full length) sleeve can be added to the roller and avoid the need for the Teflon tape bands, preventing the melt from sticking to the roller. There are specific design elements to the components of the roller, including a rubber intermediate layer and the outer sleeve, to ensure successful release of the melt and processing of the extrusion coated/laminated web. These details are discussed below and specified in the claims herein.

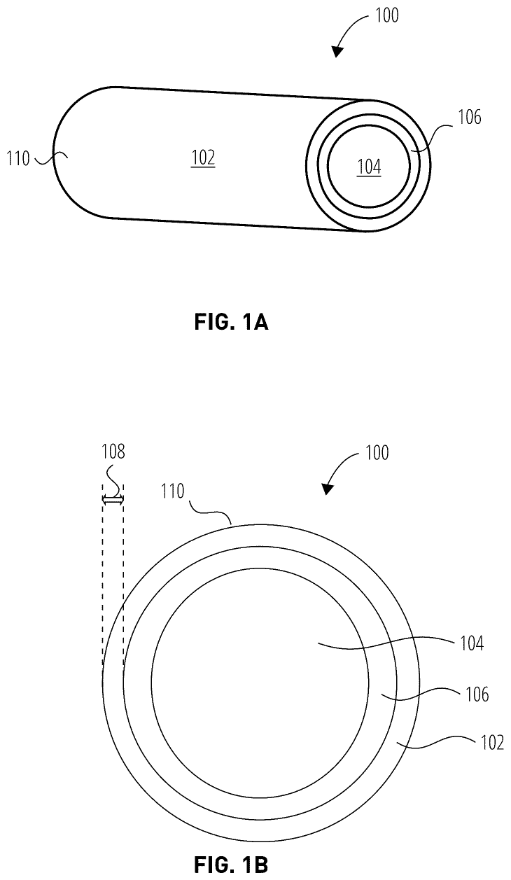

FIG. 1A illustrates an aspect of the subject matter in accordance with an embodiment of a roller 100 as described herein. The roller 100 includes a core 104, an outer sleeve 102 and an intermediate layer 106. The exposed surface 110 of the rollers 100 includes the outer sleeve 102. The roller 100 is specifically configured for use in an extrusion nip assembly including direct exposure to an extruded polymer melt.

As used herein, “extruded polymer melt” refers to a flat web of melted thermoplastic polymer immediately after it exits a forming die and before it is cooled and solidified into the sheet shape. The polymer may be one or more of a wide variety of polyolefins. The polymer may be a copolymer of polyethylene. The extruded polymer melt may be a blend of one or more polymers. The extruded polymer melt may be a single homogeneous layer or multiple distinct layers, each having a distinct composition.

The core of the roller can be of any standard material. Typical core materials for rollers used in an extrusion nip assembly include steel bases. Steel bases are known to those familiar with the art. The core may be of any suitable diameter. The diameter of the core may be less than or equal to 12, inches, less than or equal to 10 inches, less than or equal to 9 inches, less than or equal to 8 inches or less than or equal to 7 inches. The diameter of the core may be greater than or equal to 4 inches, greater than or equal to 5 inches or greater than or equal to 6 inches. For example, the core may have a diameter of 4.75 inches, 6 inches, 6.5 inches, 7 inches, 7.5 inches or 8.25 inches. The core may have a diameter in a range of from 5 inches to 9 inches, or in a range of from 6 inches to 7.5 inches.

The intermediate layer is positioned to cover the core of the roller. The intermediate layer is made of a rubber material, which may be a chlorosulfonated polyethylene synthetic rubber or a silicone based rubber. As used herein, “chlorosulfonated polyethylene synthetic rubber” or “chlorosulfonated polyethylene rubber” refers to a polymer having oil resistance, UV stability and low gas permeability. Chlorosulfonated polyethylene synthetic rubber is well known as an older version of the Hypalon product, marketed by DuPont Performance Elastomers. As used herein, “silicone based rubber” refers to a synthetic elastomer made from silicon, oxygen, and other elements, prized for its flexibility, heat resistance, and chemical stability. The intermediate layer may comprise or consist of the rubber material.

Selection of the intermediate layer composition should be made based on the hardness of the intermediate layer. As used herein, “shore hardness” or “hardness” refers to a measurement of the hardness of rubber or other material. Shore Hardness is a depth measurement method indicating an indentation depth of a spring-loaded indenter (i.e., durometer) that is held against the surface of the material. The indenter is a hardened steel pin, with different pin and steel ball designs depending on the Shore method. The indentation depth is a measurement for Shore Hardness that is determined on a scale of 0 Shore (2.5 millimeter indentation depth) to 100 Shore (0 millimeter indentation depth). Variations in the indenter pin and spring characteristics are standardized under scales such as Shore A, used for soft rubbers and similar materials, or Shore D, used for harder plastics. As used herein, all references to Shore Hardness are pointing to the Shore A scale and measured according to ASTM D2240.

The intermediate layer may have a hardness greater than or equal to 40, greater than or equal to 45, or greater than or equal to 50, as measured by ASTM D2240 according to the Shore A scale. The intermediate layer may have a hardness less than or equal to 70, less than or equal to 65 or less than or equal to 60, as measured by ASTM D2240 according to the Shore A scale. For example, the intermediate layer may have a hardness in a range of from 45 to 65 or in a range of from 40 to 70. The measurement of hardness is taken on the intermediate layer after it has been applied to the core of the roller.

The outer sleeve is positioned to cover the intermediate layer such that the intermediate layer is between the core and the outer sleeve. The outer sleeve is the outermost component of the roller. The outer sleeve is made of a material that will release from the extruded polymer melt, such as fluorinated ethylene polymer (FEP) or perfluoroalkoxy alkane (PFA). As used herein, “Fluorinated ethylene polymer (FEP)” refers to a copolymer of ethylene and tetrafluoroethylene. An example of a fluorinated ethylene polymer (FEP) is a fluorinated ethylene propylene which is a copolymer of hexafluoropropylene and tetrafluoroethylene.

Fluorinated ethylene propylene was invented by DuPont™ and is sold under the brandname Teflon® FEP. Other brandnames are Neoflon FEP from Daikin or Dyneon™ FEP from 3M™. As used herein, “Perfluoroalkoxy alkane (PFA)” refers to fluoropolymers that are copolymers of tetrafluoroethylene (C₂F₄) and perfluoroethers (C₂F₃OR^{f}), where R^{f} is a perfluorinated group such as trifluoromethyl (CF₃). The properties of these polymers are similar to those of polytetrafluoroethylene (PTFE). The outer sleeve may comprise or consist of fluorinated ethylene polymer (FEP) or perfluoroalkoxy alkane (PFA).

The exposed surface of the outer sleeve is the exposed surface of the roller. The exposed surface of the outer sleeve may be polished in order to generate a surface with increased smoothness (i.e., lower roughness). The increased smoothness can contribute to the quality of the visual appearance of the web produced using the roller. The exposed surface of the outer sleeve may be polished to achieve an average surface roughness (Ra) in a range of from 5 Ra to 10 Ra (microns).

As used herein, “average roughness (Ra)” refers to a measurement of the relative smoothness of a surface's profile, calculated via the microscopic deviations in a surface's true form. The larger the deviation from its true form, the rougher the surface, whilst the smaller the deviation, the smoother the surface. The surface roughness of the exposed surface of the outer sleeve may be modified by polishing to remove deviations, resulting in a lower Ra measurement.

Roughness or texture of a roller surface can be acquired by measuring the roller profile using a profilometer. There are two types available, 3D Optical (white light interferometer) or 2D Contact. There are many different roughness parameters in use, but Ra, the arithmetic average of absolute values of peaks & valleys of the sample length measured, is the most common referred to in the roller manufacturing industry.

The radial thickness of the outer sleeve may be greater than or equal to 0.020 inches, greater than or equal to 0.025 inches, greater than or equal to 0.030 inches or greater than or equal to 0.035 inches. The radial thickness of the outer sleeve may be less than or equal to 0.060 inches, less than or equal to 0.055 inches, less than or equal to 0.050 inches or less than or equal to 0.045 inches. For example, the radial thickness may be in a range of from 0.030 inches to 0.055 inches, or in a range of from 0.020 inches to 0.060 inches.

The roller 100 may be configured as shown in FIG. 1A and FIG. 1B which show a non-limiting embodiment of the invention. FIG. 1A shows a perspective view and FIG. 1B shows a cross-sectional view of the roller 100. The roller is built from a core 104, an outer sleeve 102 and an intermediate layer 106 located between the core 104 and the outer sleeve 102. The intermediate layer 106 may be in direct contact with the core 104, as shown. The intermediate layer 106 may be in direct contact with the outer sleeve 102, as shown. Some embodiments may include further materials intervening between the components shown in these figures.

The outer sleeve 102 has an exposed surface 110 that may be polished. The exposed surface 110 of the outer sleeve 102 is the portion of the roller 100 that comes into direct contact with the substrate and/or extruded polymer melt of the web being processed by extrusion coating or extrusion lamination. Also shown in FIG. 1B is the radial thickness 108 of the outer sleeve 102.

The roller 100 may have a hardness greater than or equal to 55, greater than or equal to 60, or greater than or equal to 65, as measured by ASTM D2240 according to the Shore A scale. The roller may have a hardness less than or equal to 95, less than or equal to 90 or less than or equal to 85, as measured by ASTM D2240 according to the Shore A scale. For example, the roller may have a hardness in a range of from 65 to 85 or in a range of from 55 to 95. This measurement of hardness is taken on the exposed surface of the outer sleeve of the roller.

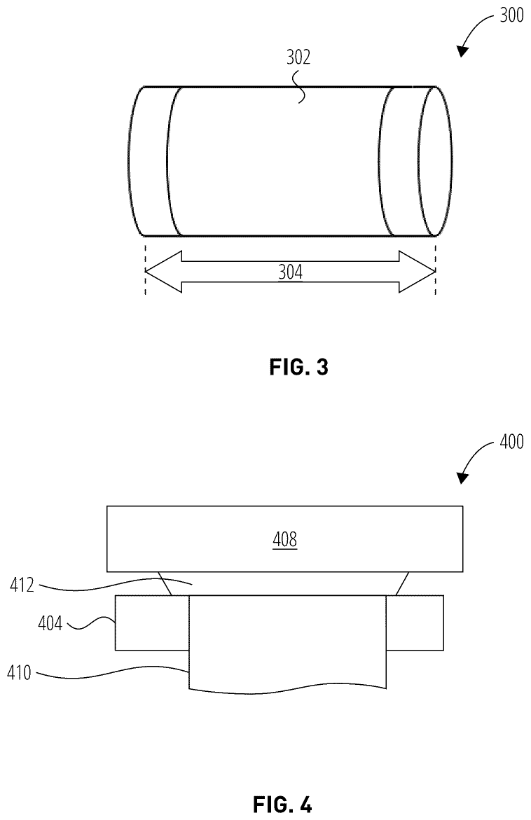

Now turning to FIG. 3, a perspective view of another embodiment of a roller 300 is shown. FIG. 3 illustrates an embodiment of a roller 300 having an outer sleeve 302 extending in a single piece along at least 50% of the length of the roller 304. The length of the roller 304 is a linear measurement of the outer surface of the roller that is flush with the exposed surface of the outer sleeve 302. Other portions of the roller not including the outer sleeve 302 may have a smaller diameter and may extend beyond the length of the roller 304.

In practice, the outer sleeve of the roller should cover the entire length of the roller that comes into contact with the web (i.e., substrate and extruded polymer melt) being processed. In some embodiments of the roller (not shown), the entirety of the outer surface of the roller is the outer sleeve. In other words, the outer sleeve extends the entire length of the roller.

FIG. 2 illustrates an embodiment of an extrusion nip assembly 200 described herein.

The extrusion nip assembly 200 includes a chill roll 202 (i.e., cooling roll) with a cold water inlet, a roller 204, a water-cooled backing roll 206, and a die 208. According to the assembly described herein, the roller 204 includes a core, an intermediate layer and an outer sleeve. During operation of the extrusion nip assembly 200, a substrate 210 (i.e., a film, a foil, a paper) is fed over the roller 204 and a web of extruded polymer melt 212 exiting the die 208 is combined with the substrate 210 at the nip point between the chill roll 202 and the roller 204.

FIG. 4 illustrates a front view of an embodiment of an extrusion nip assembly 400. The extruded polymer melt 412 is fed from the die 408 into the nip point between the chill roll (not show) and the roller 404. The substrate 410 is fed over the roller 404 such that it is between the extruded polymer melt 412 and the roller 404. From this perspective, one can see that the extruded polymer melt 412 extends beyond the edges of the substrate 410, coming into contact with the roller 404 at the overhanging edges.

As used herein, “substrate” refers to a web based material such as a polymer film, paper or foil. Examples of a substrate commonly used for extrusion coating or extrusion lamination include, but are not limited to, paper, aluminum foil, metalized OPET, non-metalized OPET, metalized OPP, non-metalized OPP, polyethylene film, cast polypropylene film or BON.

As used herein, “extruded polymer melt” refers to a flat web of melted thermoplastic polymer immediately after it exits a forming die and before it is cooled and solidified into the sheet shape. The polymer may be one or more of a wide variety of polyolefins. The polymer may be a copolymer of polyethylene. As used throughout this application, the term “polyethylene” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, or blends of such. Specifically, the polymer may be a polyethylene such as low density polyethylene or ethylene acid copolymer.

The extruded polymer melt may be a blend of one or more polymers. The extruded polymer melt may be a single homogeneous layer or multiple distinct layers, each having a distinct composition.

The extrusion nip assembly may be employed to manufacture a wide variety of film structures including, but not limited to, those typically used for flexible packaging or labels.

The method of extrusion coating or extrusion lamination includes providing an extrusion nip assembly as described herein and utilizing a roller as described herein, feeding a substrate over the roller into a nip point between the chill roll and the roller, extruding a polymer melt from the die as a flat web, combining the substrate and the extruded polymer melt at the nip point such that the extruded polymer melt is between the substrate and the chill roll and the extruded polymer melt contacts the outer sleeve of the roller at the portions of the extruded polymer melt that extend beyond each edge of the substrate, and cooling the combined substrate and extruded polymer melt with the chill roll to form a laminate. The method may also include where the extruded polymer melt extends beyond each edge of the substrate by 1 to 3 inches. The method may also include where the extruded polymer melt includes polyethylene or an ethylene acid copolymer.

### EXAMPLES

COMPARATIVE EXAMPLE 1: A roller was produced according to the details given in this disclosure, including a steel core base, a rubber intermediate layer and a fluorinated ethylene polymer (FEP) sleeve. However, the rubber of the intermediate layer had a durometer of 80, the roller had a durometer of 100 and the surface was not polished sufficiently. This roller was installed in an extrusion coater nip assembly and was used to produce an extrusion coated web product. The product produced was not satisfactory. Due to the hardness of the roller and the poor polish, the visual appearance of the extrusion coated web produced was poor and production was halted.

COMPARATIVE EXAMPLE 2: A roller was produced according to the details given in this disclosure, including a steel core base and a rubber intermediate layer. Instead of a single piece the outer sleeve was a multi-piece fixture, including rubber in the center and fluorinated ethylene polymer (FEP) pieces at each end. The FEP bands were located in the area of the extruded polymer melt overhanging the substrate during extrusion coating. The roller was installed in an extrusion nip assembly and was used to produce an extrusion coated web product. The web product had a visual defect in the area of the seam between the rubber and FEP portions of the outer sleeve. Additionally, due to the unevenness of the web and the sleeved ends, the result was wrinkles in the area of the seam. No acceptable web material was achieved using this roller.

COMPARATIVE EXAMPLE 3: A roller was produced according to the details given in this disclosure, including a steel core base, a rubber intermediate layer having a durometer of 40 and a fluorinated ethylene polymer (FEP) sleeve having a thickness of 0.020 inches. The polish on the outer sleeve was poor and the average roughness (Ra) was greater than 10 Ra (microns). The roller was installed in an extrusion nip assembly and was used to produce an extrusion coated web product. While the roller and extrusion nip performed well with minor visual defects in most areas along with a grainy appearance across the entire web and not acceptable for most applications. The roller did hold up well and was able to make good product, albeit with less than desirable appearance, for over 14 days and then removed due to the defects becoming more prevalent.

COMPARATIVE EXAMPLE 4: A roller was produced according to the details given in this disclosure, including a steel core base, a rubber intermediate layer and a fluorinated ethylene polymer (FEP) sleeve having a thickness of 0.030 inches. The roller had a durometer of 45. The polish on the outer sleeve was poor and the average roughness (Ra) was greater than 10 Ra (microns). The roller was installed in an extrusion nip assembly and was used to produce an extrusion coated web product. While the roller and extrusion nip performed well in most areas, the visual appearance of the web was grainy and not acceptable for most applications.

EXAMPLE 5: A roller was produced according to the details given in this disclosure, including a 6.5 inch diameter steel base (core), a Hypalon rubber coating on the core having a radial thickness of 0.5 inches and a durometer of 40 to 50 (Shore A hardness), a polished fluorinated ethylene polymer (FEP) sleeve with a radial thickness of 0.02 inches, and overall durometer of about 60 to 70 (Shore A hardness). This roller was used in an extrusion nip assembly, extruding an EAA based polymer having a melt temperature of approximately 585° F. The extruded melt web extended beyond the substrate being coated by about 1 to 1.5 inches on each edge and was in direct contact with the sleeve of the roller at each of these extended edges. No Teflon belts were used to shield the roller. Line speeds ranged from 100 to 1,000 feet per minute. Several weeks of production were successfully run without any downtime due to roll wraps.

EXAMPLE 6: A roller was produced according to the details given in this disclosure, including a 7.5 inch diameter steel base (core), a Hypalon rubber coating on the core having a radial thickness of 0.5 inches and a durometer of 45 (Shore A hardness), a polished fluorinated ethylene polymer (FEP) sleeve with a radial thickness of 0.02 inches and a roughness of 5 to 10 RA. The roller had a durometer of about 70 (Shore A hardness). The roller was tested in the same process as described in Example 5, with the same success.

Prior to the above noted successful test of the roller, other attempts were made to eliminate the need for the Teflon belts. First, a Teflon spray was used over the rubber roller. This did not work at all as the polymer melt immediately stuck to the surface of the roller. Second, an FEP sleeve was applied to a rubber roller that had a high durometer (80 to 90). This resulted in a surface that was acceptable for anti-stick properties (i.e., adhesion), but caused so many wrinkles in the substrate and an unacceptable product, that it could not be tested for long periods of time. Third, a roller with an FEP sleeve having 60 durometer and 0.60 thickness was used with extrusion temperatures closer to 600 degrees. This solution was not durable enough as the sleeve became distorted in the areas in contact with the hot extrudate, and the distortion caused visual issues in the films.

### EMBODIMENTS

Embodiment 1: A roller configured for contact with an extruded polymer melt, the roller comprising: a core comprising a steel base; an intermediate layer comprising rubber; an outer sleeve comprising fluorinated ethylene polymer (FEP) or perfluoroalkoxy alkane (PFA); and a hardness in a range of from 55 to 95, as measured by ASTM D2240 according to the Shore A scale.

Embodiment 2: The roller configured for extruded polymer melt contact of embodiment 1 wherein the outer sleeve extends in a single piece along at least 50% of the length of the roller.

Embodiment 3: The roller configured for extruded polymer melt contact of any previous embodiment wherein the intermediate layer comprises a hardness in a range of from 40 to 70, as measured by ASTM D2240 according to the Shore A scale.

Embodiment 4: The roller configured for extruded polymer melt contact of any previous embodiment wherein an exposed surface of the outer sleeve is polished.

Embodiment 5: The roller configured of embodiment 4 wherein the exposed surface has an average roughness (Ra) in a range of from 5 Ra (microns) to 10 Ra (microns).

Embodiment 6: The roller configured for extruded polymer melt contact of any previous embodiment wherein the outer sleeve has a radial thickness in a range of from 0.020 to 0.060 inches (0.51 to 1.52 mm).

Embodiment 7: The roller configured for extruded polymer melt contact of any previous embodiment wherein the rubber is a chlorosulfonated polyethylene synthetic rubber or a silicone based rubber.

Embodiment 8: The roller configured for extruded polymer melt contact of any previous embodiment wherein the core has a diameter in a range of from 6 inches to 7.5 inches (15.24 cm to 19.05 cm).

Embodiment 9: The roller configured for extruded polymer melt contact of any previous embodiment wherein the intermediate layer is in direct contact with each of the core and the outer sleeve.

Embodiment 10: A roller configured for contact with an extruded polymer melt, comprising:
a core comprising a steel base;
an intermediate layer comprising a rubber selected from chlorosulfonated polyethylene synthetic rubber or silicone-based rubber; and
an outer sleeve comprising fluorinated ethylene polymer (FEP) or perfluoroalkoxy alkane (PFA), the outer sleeve comprising a polished exposed surface with an average roughness in a range of 5 to 10 Ra (microns), and extending in a single piece along at least 50% of the length of the roller;
wherein the roller has a hardness in a range of 55 to 95 as measured by ASTM D2240 according to the Shore A scale, and the intermediate layer is in direct contact with both the core and the outer sleeve.

Embodiment 11: The roller of embodiment 10, wherein the intermediate layer comprises a hardness in a range of 40 to 70 as measured by ASTM D2240 according to the Shore A scale.

Embodiment 12: The roller of embodiment 10 or 11, wherein the outer sleeve comprises a radial thickness in a range of from 0.020 to 0.060 inches (0.51 to 1.52 mm).

Embodiment 13: The roller of embodiment 10, 11 or 12 wherein the core has a diameter in a range of from 6 inches to 7.5 inches (15.24 cm to 19.05 cm).

Embodiment 14: The roller of embodiment 10, 11, 12 or 13 wherein the intermediate layer is in direct contact with each of the core and the outer sleeve.

Embodiment 15: The roller of embodiment 10, 11, 12, 13 or 14, wherein the outer sleeve extends along substantially the entire length of the roller.

Embodiment 16: An extrusion nip assembly comprising: a chill roll; a water-cooled backing roll; a roller according to any previous embodiment; and a die.

Embodiment 17: A method of extrusion coating or extrusion lamination comprising:
providing the extrusion nip assembly according to embodiment 16;
feeding a substrate over the roller into a nip point between the chill roll and the roller;
extruding a polymer melt from the die as a flat web;
combining the substrate and an extruded polymer melt at the nip point such that the extruded polymer melt is between the substrate and the chill roll and the extruded polymer melt contacts the outer sleeve of the roller at the portions of the extruded polymer melt that extend beyond each edge of the substrate; and
cooling the combined substrate and extruded polymer melt with the chill roll to form a laminate.

Embodiment 18: The method of embodiment 17, wherein the extruded polymer melt extends beyond each edge of the substrate by 1 to 3 inches.

Embodiment 19: The method of embodiment 17 or 18, wherein the extruded polymer melt comprises polyethylene or an ethylene acid copolymer.

Embodiment 20: The method of embodiment 17, 18 or 19, wherein a line speed of the extrusion coating or extrusion lamination is in a range of 100 to 1,500 feet per minute.

What is claimed is:

1. A roller configured for contact with an extruded polymer melt, the roller comprising:
a core comprising a steel base;
an intermediate layer comprising rubber;
an outer sleeve comprising fluorinated ethylene polymer (FEP) or perfluoroalkoxy alkane (PFA); and
a hardness in a range of from 55 to 95, as measured by ASTM D2240 according to the Shore A scale.

2. The roller configured for extruded polymer melt contact of claim 1 wherein the outer sleeve extends in a single piece along at least 50% of the length of the roller.

3. The roller configured for extruded polymer melt contact of claim 1 wherein the intermediate layer comprises a hardness in a range of from 40 to 70, as measured by ASTM D2240 according to the Shore A scale.

4. The roller configured for extruded polymer melt contact of claim 1 wherein an exposed surface of the outer sleeve is polished.

5. The roller configured of claim 4 wherein the exposed surface has an average roughness (Ra) in a range of from 5 Ra (microns) to 10 Ra (microns).

6. The roller configured for extruded polymer melt contact of claim 1 wherein the outer sleeve has a radial thickness in a range of from 0.020 to 0.060 inches (0.51 to 1.52 mm).

7. The roller configured for extruded polymer melt contact of claim 1 wherein the rubber is a chlorosulfonated polyethylene synthetic rubber or a silicone based rubber.

8. The roller configured for extruded polymer melt contact of claim 1 wherein the core has a diameter in a range of from 6 inches to 7.5 inches (15.24 cm to 19.05 cm).

9. The roller configured for extruded polymer melt contact of claim 1 wherein the intermediate layer is in direct contact with each of the core and the outer sleeve.

10. A roller configured for contact with an extruded polymer melt, comprising:
a core comprising a steel base;
an intermediate layer comprising a rubber selected from chlorosulfonated polyethylene synthetic rubber or silicone-based rubber; and
an outer sleeve comprising fluorinated ethylene polymer (FEP) or perfluoroalkoxy alkane (PFA), the outer sleeve comprising a polished exposed surface with an average roughness in a range of 5 to 10 Ra (microns), and extending in a single piece along at least 50% of the length of the roller;
wherein the roller has a hardness in a range of 55 to 95 as measured by ASTM D2240 according to the Shore A scale, and the intermediate layer is in direct contact with both the core and the outer sleeve.

11. The roller of claim 10, wherein the intermediate layer comprises a hardness in a range of 40 to 70 as measured by ASTM D2240 according to the Shore A scale.

12. The roller of claim 10, wherein the outer sleeve comprises a radial thickness in a range of from 0.020 to 0.060 inches (0.51 to 1.52 mm).

13. The roller of claim 10 wherein the core has a diameter in a range of from 6 inches to 7.5 inches (15.24 cm to 19.05 cm).

14. The roller of claim 10 wherein the intermediate layer is in direct contact with each of the core and the outer sleeve.

15. The roller of claim 10, wherein the outer sleeve extends along substantially the entire length of the roller.

16. An extrusion nip assembly comprising:
a chill roll;
a water-cooled backing roll;
a roller according to claim 1; and
a die.

17. A method of extrusion coating or extrusion lamination comprising:
providing the extrusion nip assembly according to claim 16;
feeding a substrate over the roller into a nip point between the chill roll and the roller;
extruding a polymer melt from the die as a flat web;
combining the substrate and an extruded polymer melt at the nip point such that the extruded polymer melt is between the substrate and the chill roll and the extruded polymer melt contacts the outer sleeve of the roller at the portions of the extruded polymer melt that extend beyond each edge of the substrate; and
cooling the combined substrate and extruded polymer melt with the chill roll to form a laminate.

18. The method of claim 17, wherein the extruded polymer melt extends beyond each edge of the substrate by 1 to 3 inches.

19. The method of claim 17, wherein the extruded polymer melt comprises polyethylene or an ethylene acid copolymer.

20. The method of claim 17, wherein a line speed of the extrusion coating or extrusion lamination is in a range of 100 to 1,500 feet per minute.
